(19) United States
(12) Patent Application Publication
(10) Pub. No.: US 2009/0063368 A1
(43) Pub. Date: Mar. 5, 2009

(54) DATA PROCESSING APPARATUS AND DATA PROCESSING METHOD

(76) Inventor: Kouichi Morishita, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/176,452

(22) Filed: Jul. 21, 2008

(30) Foreign Application Priority Data
Aug. 29, 2007 (JP) 2007-222167

(51) Int. Cl. G06F 1/00; G06Q 30/00

(52) U.S. Cl. 705/400; 726/30; 705/1

(57) ABSTRACT

An extended function of an apparatus at a data distributed destination is managed by an apparatus at a data distributing source. An image input unit reads a document and generates image data, which is encrypted by an encrypting unit, generating encrypted document data. An allowance code generating unit generates an allowance code allowing decryption of the encrypted document data and sends it to a code attaching unit. The code attaching unit attaches the allowance code to the encrypted document data and sends the data to a data distribution unit, which sends the data to an image processing apparatus at a data distributed destination. At the data distributed destination, the allowance code is separated from the distributed data, and a decrypting unit is operated based on the allowance code and the encrypted document data is decrypted.

### BACKGROUND OF THE INVENTION

1. Field of the Invention

The present invention generally relates to data processing apparatuses having an extended function managing unit, and data processing methods.

2. Description of the Related Art

A multifunction peripheral offers the functionality of multiple devices, such as a copier, a facsimile machine, and a printer. Due to their space-saving property and other advantages, multifunction peripherals are being increasingly installed in offices, supplanting the single-function copiers and the like. Information processing systems have also become common in which multiple computers are connected via a network, so that resources, such as a printer, connected to the same network can be shared. As a result, users' expectations from multifunction peripherals are continually diversifying.

To meet various user demands, a variety of functions are provided in a multifunction peripheral. Some of these functions, however, may not be useful to some users. Japanese Laid-Open Patent Application No. 2006-14082 discloses that functions that are expected to be utilized by only some of the users are implemented by adding an extension board and a program for running it. Japanese Laid-Open Patent Application No. 2005-33277 discloses a multifunction peripheral in which, in order to eliminate the need to add such an extension board and program, certain functions are implemented in hardware and software but are set so that the functions are not utilizable by default. The certain functions are made utilizable only upon attachment of a function-limit-resetting device by a user.

However, in the case where the extended function is introduced by adding an extension board and a program, the extended function is only usable in an apparatus into which the extended function is introduced. For example, when a data encryption function is added as an extended function to a scanner distribution function in which image data read by a scanner is transferred to another multifunction peripheral or computer for display or other type of output, the output device needs to have the same encryption-decryption function. Thus, the possible scope of application of the extended function is limited, which reduces the effect of introducing the extended function from the viewpoint of the user.

In the multifunction peripheral in which an extended function is made usable upon attaching a function-limit-resetting device, there is the problem that, when the multifunction peripheral is a data distributed destination, the extended function at the distributed destination cannot be managed from the distributing source.

### SUMMARY OF THE INVENTION

It is a general object of the present invention to provide a data processing apparatus and a data processing method in which the aforementioned problems are eliminated. A more specific object is to enable the management of an extended function of an apparatus at a data destination by a data source device.

In one aspect, the invention provides a data processing apparatus comprising a unit configured to generate use allowance information allowing data to be processed at a data destination using an extended function; and a unit configured to send the data and the use allowance information.

In a preferred embodiment, the data processing apparatus includes a unit configured to generate billing information regarding a use of the extended function or an extended function executing program at the data destination when the data and the use allowance information, or the data and the extended function executing program are sent.

In another preferred embodiment, the unit configured to generate the billing information generates billing information corresponding to an amount of the input data.

In another aspect, the invention provides a data processing apparatus comprising an extended function unit configured to process input data using an extended function; and an extended function control unit configured to operate the extended function unit based on use allowance information inputted with the input data that allows the data to be processed using the extended function.

In another aspect, the invention provides a data processing method comprising a step of generating use allowance information allowing data to be processed at a data destination using an extended function; and a step of sending the data and the use allowance information.

In a preferred embodiment, the method includes a step of generating billing information for a use of the extended function or an extended function executing program at the data destination when the data and the use allowance information, or the data and the extended function executing program are sent.

In a preferred embodiment, the method includes a step of determining a data amount of input data. The step of generating the billing information generates billing information corresponding to the data amount.

In accordance with the present invention, an extended function of an apparatus at a data distributed destination can be managed by an apparatus at a data distributing source.

### BRIEF DESCRIPTION OF THE DRAWINGS

These and other objects, features and advantages of the invention will be apparent to those skilled in the art from the following detailed description of the invention, when read in conjunction with the accompanying drawings in which:

FIG. 1 shows a block diagram of an image processing apparatus at a data distributing source in a data processing system according to a first embodiment of the present invention;

FIG. 2 shows a block diagram of an image processing apparatus at a data distributed destination in the data processing system according to the first embodiment;

FIG. 3 shows a flowchart of an operation of the image processing apparatus at the data distributing source in the data processing system according to the first embodiment;

FIG. 4 shows a flowchart of an operation of the image processing apparatus at the data distributed destination in the data processing system according to the first embodiment;

FIG. 5 shows a block diagram of an image processing apparatus at a data distributing source in a data processing system according to a second embodiment of the present invention;

FIG. 6 shows a block diagram of an image processing apparatus at a data distributed destination in the data processing system according to the second embodiment;

FIG. 7 shows a flowchart of an operation of the image processing apparatus at the data distributing source in the data processing system according to the second embodiment;

FIG. 8 shows a flowchart of an operation of the image processing apparatus at the data distributed destination in the data processing system according to the second embodiment;

FIG. 9 shows a block diagram of an image processing apparatus at the data distributing source in a data processing system according to a third embodiment of the present invention;

FIG. 10 shows a block diagram of the image processing apparatus at the data distributed destination in a data processing system according to the third embodiment;

FIG. 11 shows a block diagram of an image processing apparatus at the data distributing source in a data processing system according to a fourth embodiment of the present invention;

FIG. 12 shows a flowchart of an operation of the image processing apparatus at the data distributing source in the data processing system at the fourth embodiment;

FIG. 13 shows a block diagram of an image processing apparatus at the data distributing source in a data processing system according to a fifth embodiment of the present invention;

FIG. 14 shows a block diagram of the image processing apparatus at the data distributing source in the data processing system according to the sixth embodiment;

FIG. 15 shows a block diagram of an image processing apparatus at the data distributed destination in a data processing system according to the sixth embodiment;

FIG. 16 shows a flowchart of an operation of the image processing apparatus at the data distributing source in the data processing system according to the sixth embodiment;

FIG. 17 shows a flowchart of an operation of the image processing apparatus at the data distributed destination in the data processing system according to the sixth embodiment;

FIG. 18 shows a flowchart of an operation of an image processing apparatus at the data distributing source in a data processing system according to a seventh embodiment; and

FIG. 19 shows a flowchart of an operation of an image processing apparatus at the data distributed destination in the data processing system according to the seventh embodiment.

### DETAILED DESCRIPTION OF THE PREFERRED EMBODIMENTS

Hereafter, embodiments of the present invention are described with reference to the drawings.

### Embodiment 1

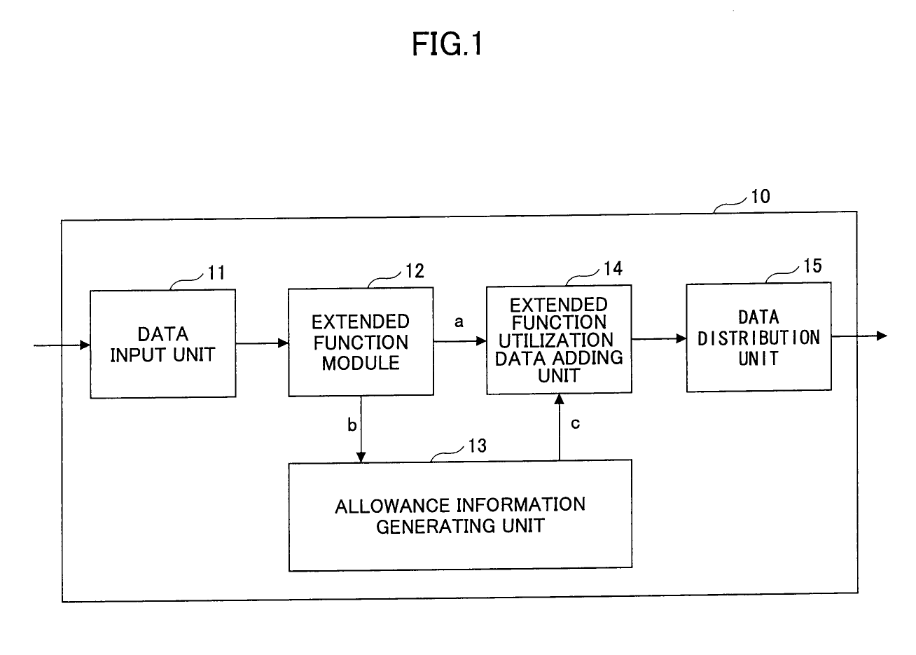

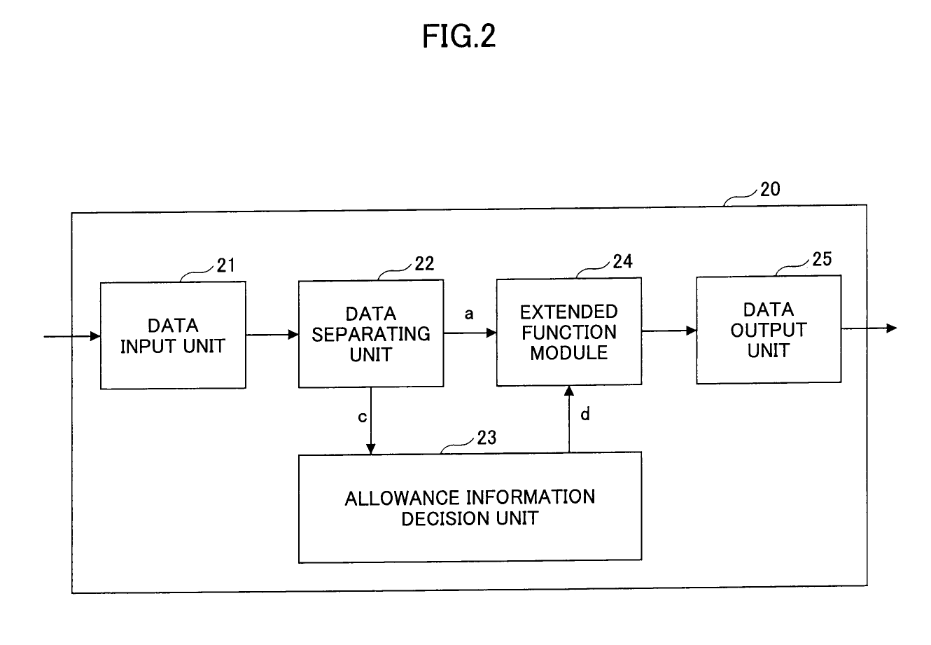

FIGS. 1 and 2 show block diagrams of image processing apparatuses at a data distributing source and a data distributed destination, respectively, in a data processing system according to a first embodiment of the present invention. The data processing system of the present embodiment may include one image processing apparatus at a data distributing source, one or more image processing apparatuses at data distributed destinations, and a wireless or wired data transmission path (not shown) by which the data distributing source and the data distributed destinations are connected. This system configuration is the same for the second through the seventh embodiments.

With reference to FIG. 1, an image processing apparatus 10 at the data distributing source includes a data input unit 11, an extended function module 12, an allowance information generating unit 13, an extended-function-utilization-data adding unit 14, and a data distribution unit 15.

The data input unit 11 receives image data from the outside. The entered image data is processed by the extended function module 12 using a predetermined extended function, whereby processed image data a is generated. The processed image data a is delivered to the extended-function-utilization-data adding unit 14, while extended function utilization request information b is generated and delivered to the allowance information generating unit 13.

The extended function utilization request information b includes ID information identifying an image processing apparatus 20 (FIG. 2) at a data distributed destination designated by a user using an operating unit (not shown). The extended function utilization request information b also includes information indicating that the use of an extended function module 24 of the image processing apparatus 20 is allowed. The user, when distributing the same image data to plural data processing apparatuses, may either allow all of the data processing apparatuses to use the extended function module 24, or allow only one or some of the data processing apparatuses to use the extended function module 24.

The allowance information generating unit 13, based on the entered extended function utilization request information b, issues an extended function use allowance code c, and delivers it to the extended-function-utilization-data adding unit 14. The extended-function-utilization-data adding unit 14 adds the extended function use allowance code c to the image data a to generate distribution data, and sends it to the data distribution unit 15. The data distribution unit 15 then distributes the entered distribution data to the designated distributed destination.

With reference to FIG. 2, the image processing apparatus 20 at the data distributed destination includes a data input unit 21, a data separation unit 22, an allowance information decision unit 23, the extended function module 24, and a data output unit 25.

The data input unit 21 receives the distributed data from the image processing apparatus 10, and sends it to the data separation unit 22. The data separation unit 22 determines whether the entered distributed data contains the extended function use allowance code c. If it does, the data separation unit 22 separates the distributed data into the image data a and the extended function use allowance code c, and sends them to the extended function module 24 and the allowance information decision unit 23, respectively. If the distributed data does not contain the extended function use allowance code c, the data separation unit 22 sends the image data a to the extended function module 24.

The allowance information decision unit 23, based on the entered extended function use allowance code c, generates extended function use allowance information d, and outputs it to the extended function module 24. The extended function module 24, based on the input of the extended function use allowance information d, processes the image data a based on a predetermined extended function, thereby generating processed image data which is sent to the data output unit 25. The data output unit 25 then outputs the entered image data to the outside.

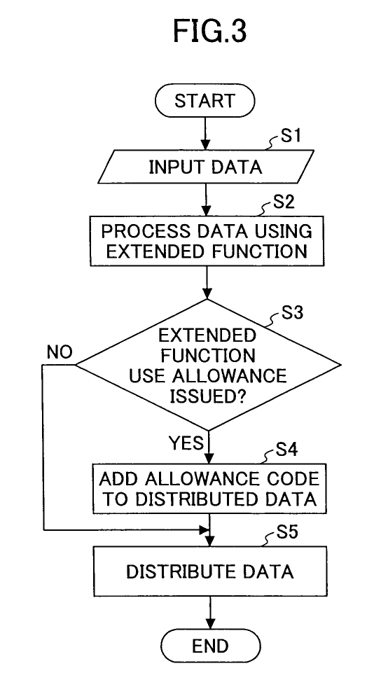

FIG. 3 shows a flowchart of an operation of the image processing apparatus 10.

In step S1, image data is entered into the data input unit 11. In step S2, the extended function module 12 processes the entered image data using the extended function, generating the processed image data a.

In step S3, the extended-function-utilization-data adding unit 14 determines whether the extended function use allowance code c is issued. If it is issued (YES in S3), the extended-function-utilization-data adding unit 14 in step S4 attaches the extended function use allowance code c to the image data a and thereby generates the distribution data. If the extended function use allowance code c is not issued (NO in S3), the extended-function-utilization-data adding unit 14 sends the entered image data a to the data distribution unit 15 as is.

Finally, in step S5, the data distribution unit 15 distributes the entered distributed data to the image processing apparatus 20.

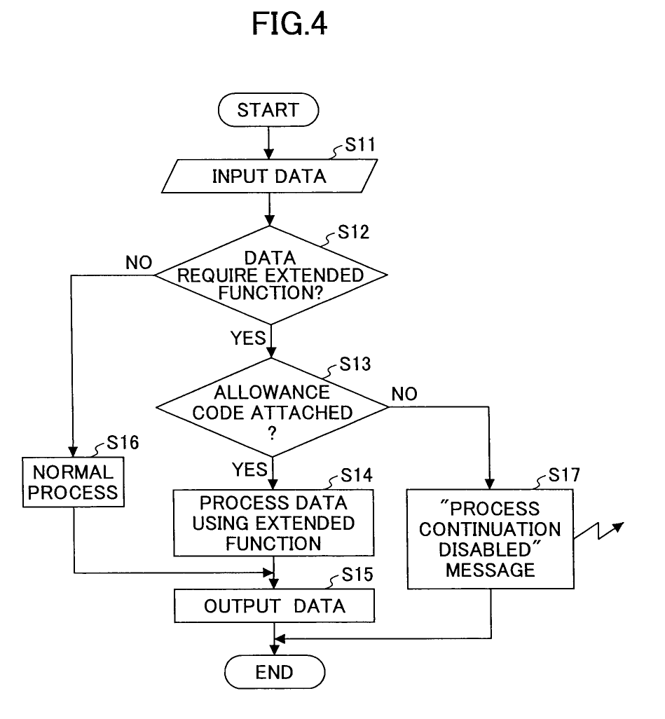

FIG. 4 shows a flowchart of an operation of the image processing apparatus 20.

In step S11, the distributed data is entered into the data input unit 21 and further sent to the data separation unit 22. The data separation unit 22 determines whether the distributed data contains the extended function use allowance code c. If it does, the data separation unit 22 separates the distributed data into the image data a and the extended function use allowance information c, and delivers the former to the extended function module 24 and the latter to the allowance information decision unit 23. If the distributed data does not contain the extended function use allowance code c, the data separation unit 22 sends the image data d to the extended function module 24.

In step S12, the extended function module 24 determines whether the processing of the image data a requires the use of the extended function module 24. If it is determined that the extended function module 24 is required (YES in S12), the allowance information decision unit 23 in step S13 determines whether the extended function use allowance code c is attached. If it is (YES in S13), the extended function module 24 in step 14 processes the image data a using the extended function, and sends the processed data to the data output unit 25. In step S15, the data output unit 25 outputs the image data.

If it is determined in step S12 that the use of the extended function module 24 is not required for the processing of the image data a (NO in S12), the extended function module 24 in step S16 sends the entered image data to the data output unit 25 without processing the image data based on the extended function. If it is determined in step S13 that the extended function use allowance code c is not attached (NO in S13), a message (such as a visual or audio message) is displayed in step S17 on a display unit (not shown), indicating that the process cannot be continued.

Thus, in accordance with the data processing system of the present embodiment, when image data is distributed, information (i.e., extended function use allowance code c) indicating that the use of the extended function module 24 of the image processing apparatus 20 at the distributed destination is allowed is attached to the image data. Thus, the use of the extended function module 24 at the distributed destination can be controlled, so that the image data can be outputted in accordance with an operation setting intended by the distributing source.

### Embodiment 2

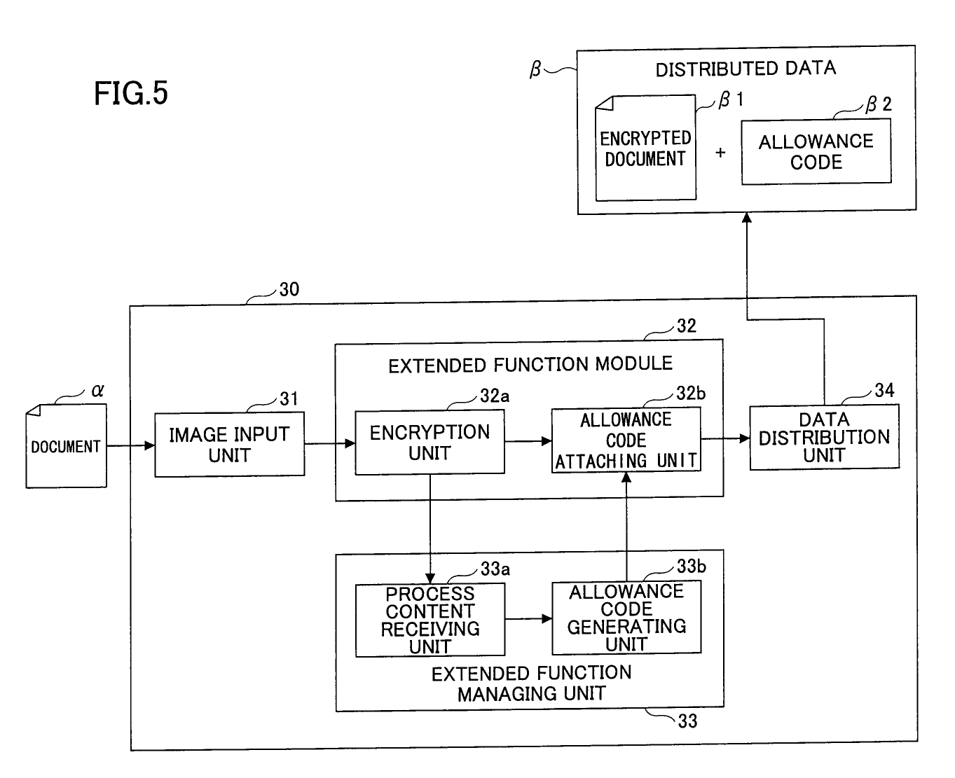

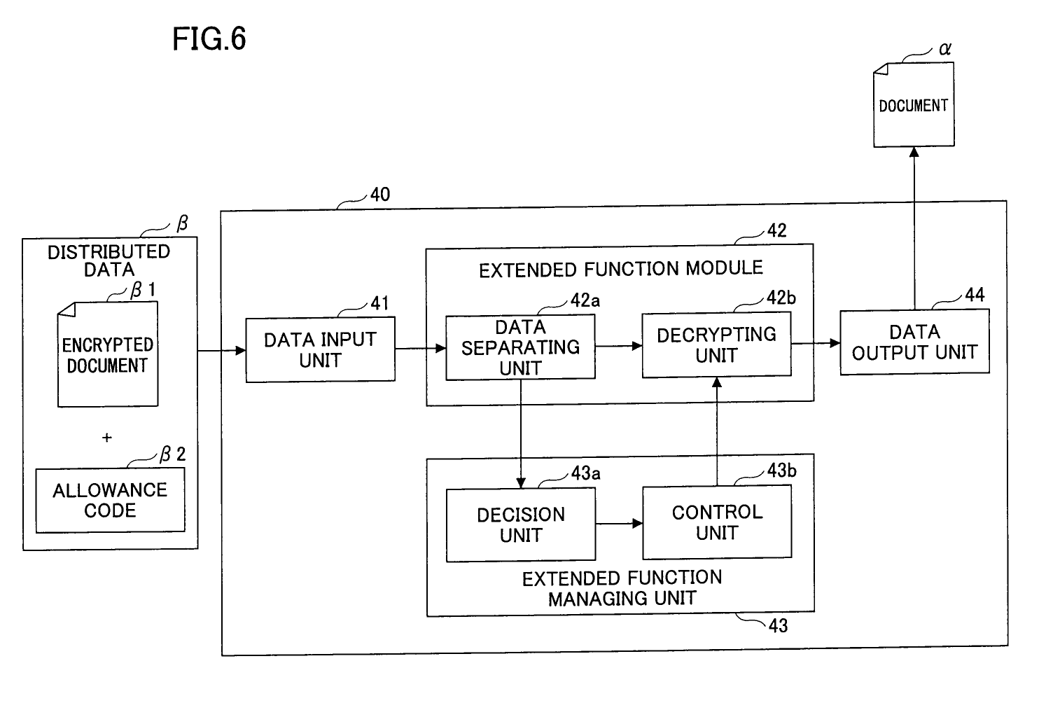

FIGS. 5 and 6 show block diagrams of image processing apparatuses at a data distributing source and a data distributed destination, respectively, in a data processing system according to a second embodiment of the invention.

With reference to FIG. 5, an image processing apparatus 30 at the data distributing source includes an image input unit 31; an extended function module 32 consisting of an encrypting unit 32a and an allowance code attaching unit 32b; an extended function management unit 33 consisting of a process content reception unit 33a and a use allowance code generating unit 33b; and a data distribution unit 34.

The image input unit 31 reads a document α and generates image data, which is encrypted by the encrypting unit 32a. Specifically, the encrypting unit 32a generates the following information simultaneously: information indicating that the image data being distributed to an image processing apparatus 40 (FIG. 6) at the data distributed destination involves the function of the encrypting unit 32a; allowance information allowing the use of the function of a decrypting unit 42b of the image processing apparatus 40 at the data distributed destination; ID information identifying the image output device 40 at the distributed destination; and period information indicating a period in which the image processing apparatus 40 at the distributed destination can utilize (decrypt) the distributed data. These items of information are sent to the process content reception unit 33a. The ID information identifying the image processing apparatus 40 may be any information enabling the identification of the apparatus, such as the apparatus' unique password, serial number, or IP address. The period information indicating the period of use of the extended function may be set as needed depending on the security level of the distributed data, the freshness of the information, and so on.

The process content reception unit 33a, based on the information sent from the encrypting unit 32a, instructs the use allowance code generating unit 33b to generate a use allowance code. The allowance code generating unit 33b generates the use allowance code and sends it to the allowance code attaching unit 32b.

The allowance code attaching unit 32b attaches the decryption-function-use-allowance code to the image data sent from the encrypting unit 32a and sends the data to the data distribution unit 34. The decryption-function-use-allowance code may be attached by incorporating it into the header of an image data file. In this way, the allowance code attaching unit 32b generates distribution data β as shown in FIG. 5, in which the decryption-function-use-allowance code, β2, is attached to the encrypted document data, β1, and sends the distribution data β to the data distribution unit 34. The data distribution unit 34 then distributes the distribution data β to the image processing apparatus 40.

With reference to FIG. 6, the image processing apparatus 40 at the data distributed destination includes a data input unit 41; an extended function module 42 consisting of a data separation unit 42a and a decrypting unit 42b; an extended function management unit 43 consisting of an allowance decision unit 43a and an allowance control unit 43b, and a data output unit 44.

The data input unit 41 receives the distribution data β distributed from the image processing apparatus 30, and sends it to the data separation unit 42a. The data separation unit 42a determines whether the distribution data β contains the decryption-function-use-allowance code β2. If it does, the data separation unit 42a separates the distribution data β into the encrypted document data β1 and the decryption-function-use-allowance code β2, and sends the former to the decrypting unit 42b and the latter to the allowance decision unit 43b. If the decryption-function-use-allowance code β2 is not contained, the data separation unit 42a sends the encrypted document data β1 to the decrypting unit 42b.

The allowance decision unit 43a analyzes the decryption-function-use-allowance code β2 and determines whether the distribution data β is addressed to the image processing apparatus 40 (i.e., confirmation of ID information); whether the period in which the use of the distribution data β is allowed has elapsed (i.e., confirmation of the period information); and whether the processing involved in the distribution data β (i.e., encryption by the encrypting unit 32a) can be handled by the extended function (i.e., the function of the decrypting unit 42b) of the image processing apparatus 40. If there are no problems, the allowance decision unit 43a issues to the allowance control unit 43b information indicating that the use of the decrypting unit 42b is allowed. The allowance control unit 43b, based on the issued use allowance information, controls the operation of the decrypting unit 42b.

The decrypting unit 42b, upon issuance of the use allowance information, decrypts the encrypted document data β1 and sends the data to the data output unit 44. The data output unit 44 then produces a printed output based on the decrypted document data, and outputs a document α.

When the allowance decision unit 43a, as a result of the analysis of the decryption-function-use-allowance code β2, determines that the identifying information is wrong, or that the processing involved in the distributed data β cannot be handled by the extended function of the image processing apparatus 40, a message (such as a visual or audio message) is displayed on a display unit (not shown), indicating that the process cannot be continued.

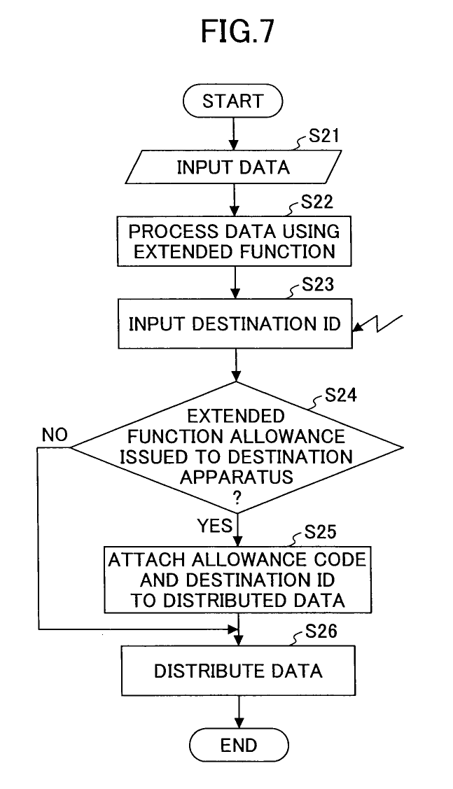

FIG. 7 shows a flowchart of an operation of the image processing apparatus 30.

In step S21, the image input unit 31 reads the document α and generates the image data. In step S22, the encrypting unit 32a processes the image data using the extended function (i.e., encryption), generating the encrypted document data β1.

In step S23, the user, using an operating unit which is not shown, enters the ID information of the image processing apparatus 40 at the data distributed destination. In step S24, the allowance code attaching unit 32b determines whether the use allowance code for the extended function (i.e., the decrypting unit 42b) of the image processing apparatus 40 is issued. If it is issued (YES in S24), the allowance code attaching unit 32b in step S25 attaches the extended function use allowance code (i.e., the decryption-function-use-allowance code P2) to the encrypted document data β1, thereby generating the distribution data β. If the use allowance code is not issued (NO in S24), the allowance code attaching unit 32b sends the entered encrypted document data β1 to the data distribution unit 34 as is.

Finally, in step S26, the data distribution unit 34 distributes the entered distributed data β to the image processing apparatus 40.

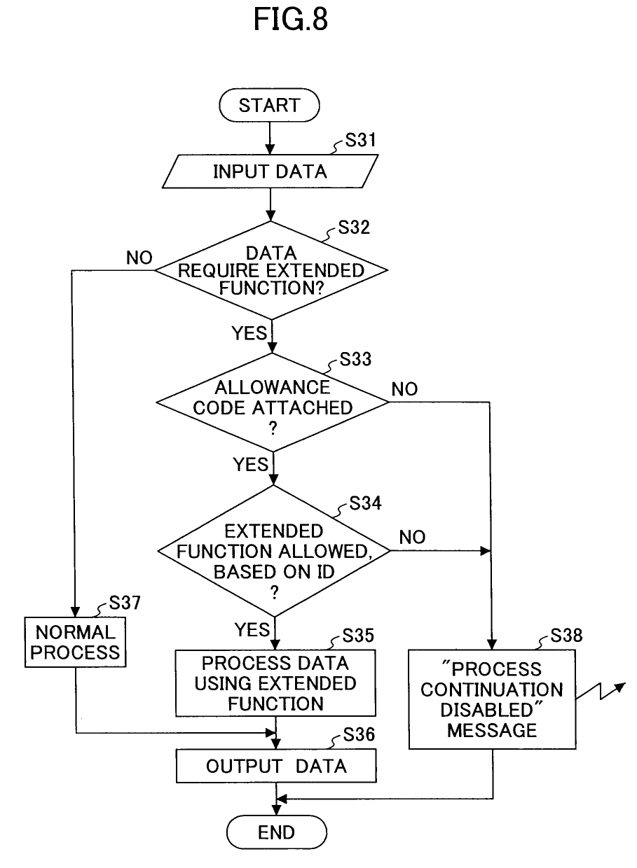

FIG. 8 shows a flowchart of an operation of the image processing apparatus 40.

In step S31, the distribution data β is entered into the data input unit 41, from which the data is further sent to the data separation unit 42a. The data separation unit 42a determines whether the distribution data contains the extended function use allowance code (i.e., the decryption-function-use-allowance code β2). If it does, the data separation unit 42a separates the distribution data β into the encrypted document data β1 and the decryption-function-use-allowance code β2, and sends the former to the decrypting unit 42b and the latter to the allowance decision unit 43a. If the extended function use allowance code is not contained, the data separation unit 42a sends the encrypted document data β1 to the decrypting unit 42b.

In step S32, the decrypting unit 42b determines whether the processing of the encrypted document data β1 requires the extended function (i.e., the decrypting unit 42b). If it does (YES in S32), the allowance decision unit 43a in step S33 determines in step S33 whether the extended function use allowance code (i.e., the decryption-function-use-allowance code β2) is attached. If it is attached (YES in S33), the allowance decision unit 43a in step 34 analyzes the extended function use allowance code β2 and determines whether the use of the extended function (i.e., the decrypting unit 42b) is allowed, based on the ID information.

If it is determined that the use is allowed, the decrypting unit 42b in step S35 processes the encrypted document data β1 using the extended function (i.e., decryption), and sends the resultant data to the data output unit 44. In step S36, the data output unit 44 produces a printed output based on the decrypted document data and outputs the document α.

If it is determined in step S32 that the use of the extended function (decrypting unit 42b) is not required (NO in S32), the decrypting unit 42b in step S37 sends the entered image data to the data output unit 44 without performing the data processing (decryption) using the extended function. If it is determined in step S33 that the extended function use allowance code is not attached (NO in S33), or, in step S34, that the use is not allowed (NO in S34), a message (such as a visual or audio message) is displayed in step S38 on a display unit (not shown) indicating that the process cannot be continued.

Thus, in accordance with the data processing system of the present embodiment, when the image data is distributed, the information (extended function use allowance code) allowing the use of the decrypting unit 42b of the image processing apparatus 40 at the distributed destination is attached to the encrypted document data. In this way, the use of the decrypting unit 42b at the distributed destination can be controlled, and the image data can be output in accordance with an operation setting intended by the distributing source.

### Embodiment 3

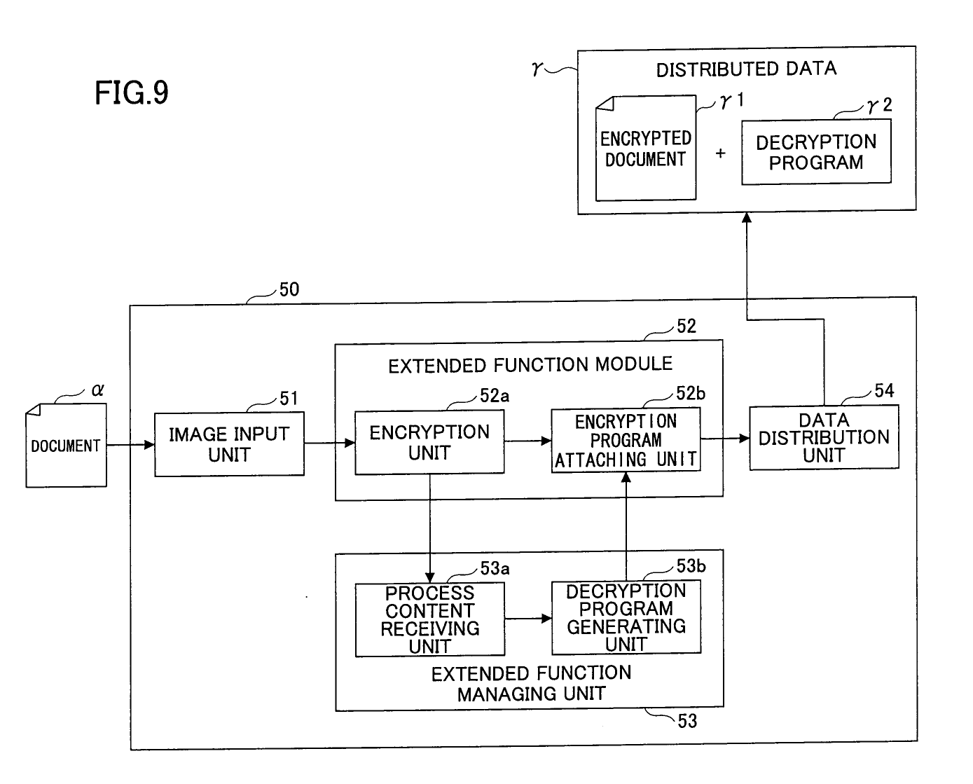

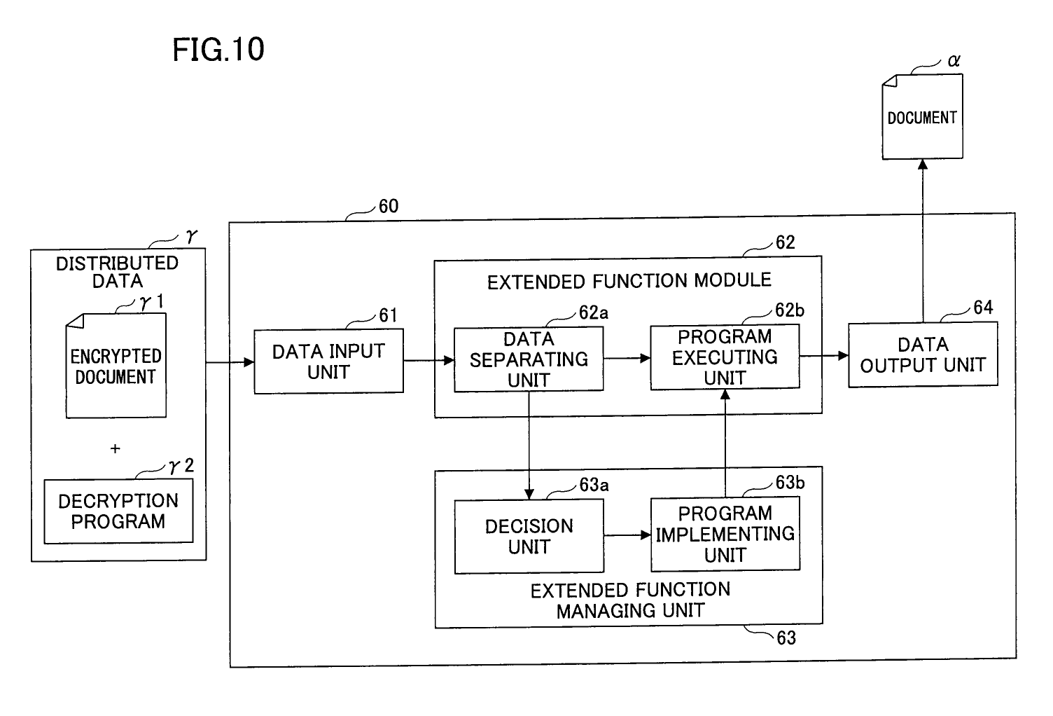

FIGS. 9 and 10 show block diagrams of image processing apparatuses at a data distributing source and a data distributed destination, respectively, in a data processing system according to a third embodiment of the invention.

With reference to FIG. 9, an image processing apparatus 50 at the data distributing source includes an image input unit 51; an extended function module 52 consisting of an encrypting unit 52a and a decryption program attaching unit 52b; an extended function management unit 53 consisting of a process content reception unit 53a and a decryption program generating unit 53b; and a data distribution unit 54.

The image input unit 51, the encrypting unit 52a, the process content reception unit 53a, and the data distribution unit 54 are similar to the image input unit 31, the encrypting unit 32a, the process content reception unit 33a, and the data distribution unit 34, respectively, of the image processing apparatus 30 according to the second embodiment.

In response to an instruction from the process content reception unit 53a, the decryption program generating unit 53b generates a program for decrypting the document data encrypted by the encrypting unit 52a, and sends the program to the decryption program attaching unit 52b. The decryption program attaching unit 52b then attaches the decryption program, γ2, sent from the decryption program generating unit 53b to the encrypted document data, γ1, from the encrypting unit 52a, thereby generating distribution data γ. The distribution data γ is sent to the data distribution unit 54, by which the distribution data γ is distributed to an image processing apparatus 60 (FIG. 10).

With reference to FIG. 10, the image processing apparatus 60 includes a data input unit 61; an extended function module 62 consisting of a data separation unit 62a and a decryption program executing unit 62b; an extended function management unit 63 consisting of an allowance decision unit 63a and a decryption program implementing unit 63b; and a data output unit 64.

The data input unit 61, the allowance decision unit 63a, and the data output unit 64 are similar to the data input unit 41, the allowance decision unit 43a, and the data output unit 44 of the image processing apparatus 40 according to the second embodiment.

The data separation unit 62a determines whether the distributed data γ contains the function extension program (i.e., decryption program γ2). If it does, the data separation unit 62a separates the function extension program and sends it to the allowance decision unit 63a, while sending the image data (i.e., the encrypted document data γ1) to the decryption program executing unit 62b. If the function extension program is not contained, the encrypted document γ1 is sent to the decryption program executing unit 62b.

The allowance decision unit 63a determines whether the extended function program (i.e., decryption program γ2) distributed by the image processing apparatus 60 can be executed, based on information such as the type of the separated program, the size of the program, and the size of available memory area. If the extended function program can be executed, the decryption program implementing unit 63b expands the decryption program, and the decryption program executing unit 62b decrypts the encrypted document data γ1 and sends the decrypted data to the data output unit 64. The data output unit 64 produces a printed output based on the decrypted document data and outputs a document α.

Thus, in accordance with the data processing system according to the present embodiment, function extension is realized by supplying software from the image processing apparatus 50 at the data distributing source. In this way, an extended function can be added when the extended function is not implemented in the image processing apparatus 60 in advance, whereby image data can be output in accordance with an operation setting intended by the distributing source.

### Embodiment 4

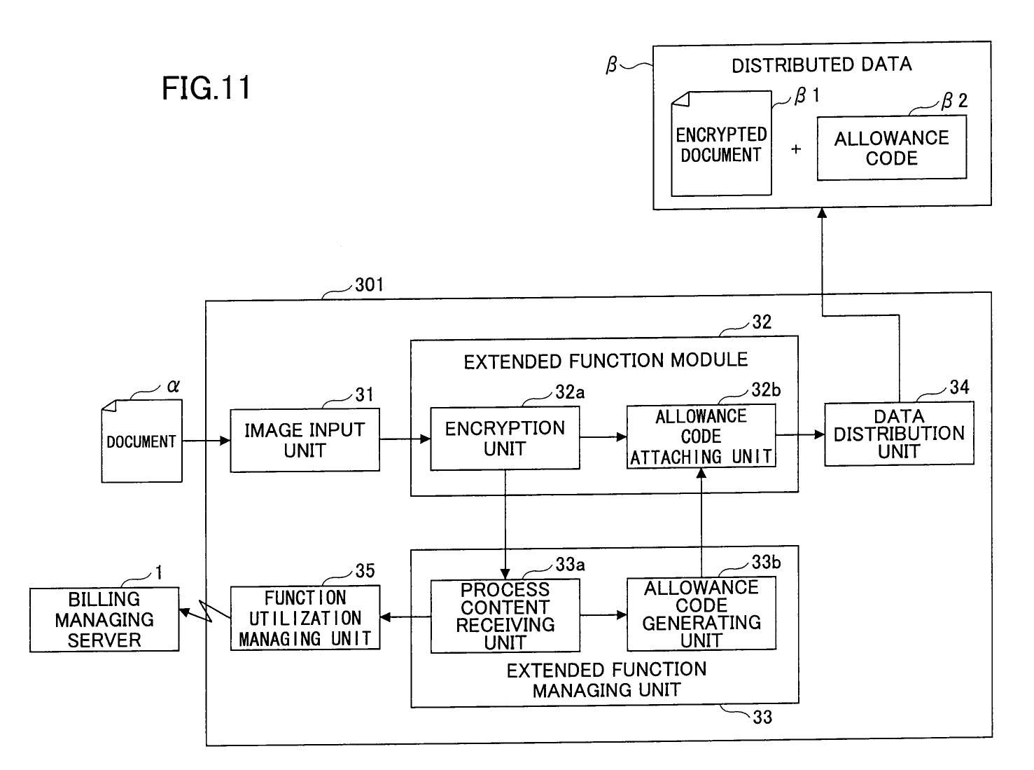

FIG. 11 shows a block diagram of an image processing apparatus 301 at the data distributing source in a data processing system according to a fourth embodiment of the invention. The image processing apparatus at the data distributed destination, on the other hand, in the present embodiment is similar to the image processing apparatus shown in FIG. 6 (the second embodiment). In FIG. 11 (i.e., the data distributing source), portions similar to those of the data distributing source of the second embodiment shown in FIG. 5 are designated with similar numerals.

The image processing apparatus 301 differs from the image processing apparatus 30 of the second embodiment in that a function utilization managing unit 35 is added. The function utilization managing unit 35 generates billing information based on the output of the process content reception unit 33a, and notifies a billing management server 1 on a network. The billing information is generated in accordance with data such as the extended function or a combination of extended functions that are utilized, the number of devices to which data is distributed, and so on.

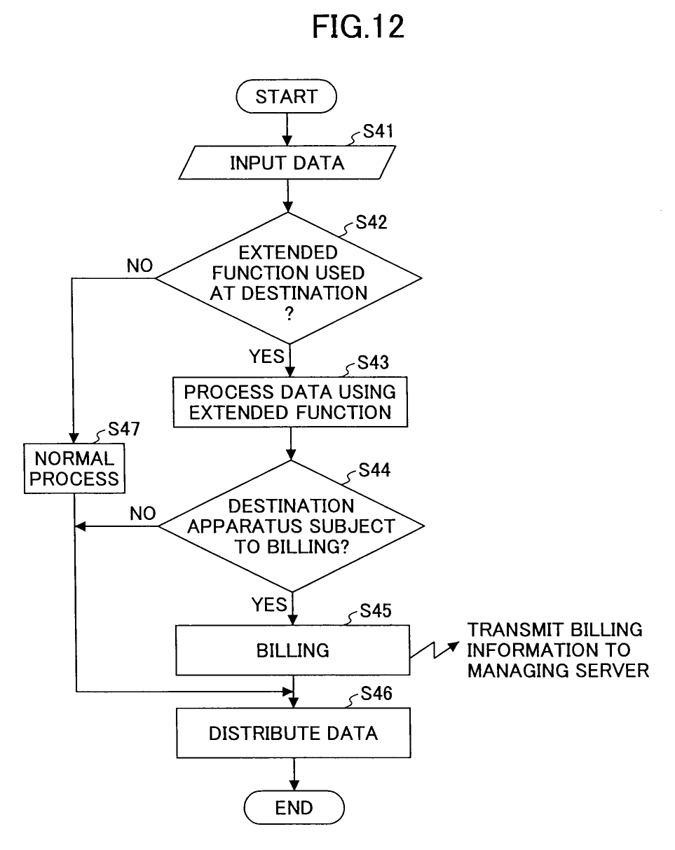

FIG. 12 shows a flowchart of an operation of the image processing apparatus 301.

In step S41, the image input unit 31 reads document α and generates image data. In step S42, the process content reception unit 33a determines whether the extended function is used in the image processing apparatus at the data distributed destination.

When it is determined that the extended function is used (YES in S42), a data processing (i.e., encryption by the encrypting unit 32a) using the extended function is performed in step S43. In step 44, it is determined whether the image processing apparatus at the distributed destination is subject to billing. If it is (YES in S44), the function utilization managing unit 35 in step S45 generates billing information and transmits it to the billing management server 1. In step S46, the data distribution unit 34 distributes the distribution data β including the encrypted document data β1 to which the extended function use allowance code (i.e., decryption-function-use-allowance code β2) is attached.

When it is determined that the extended function is not used in the image processing apparatus at the data distributed destination (NO in S42), a normal processing is performed in step S45; i.e., the image data of the document α generated in the image input unit 31 is sent to the data distribution unit 34 without encryption. When it is determined in step 44 that the image processing apparatus at the distributed destination is not subject to billing, the distribution data β is distributed without performing the billing process. The operation of the image processing apparatus at the data distributed destination is the same as that of the second embodiment.

Thus, in accordance with the data processing system of the present embodiment, billing management is carried out centrally by the image processing apparatus 301 at the data distributing source. In this way, it becomes possible to charge an amount only for the extended function used by the image processing apparatus at the data distributed destination, and also to centrally locate a billing device, thereby facilitating the management of billing. Furthermore, by having the apparatus at the data distributing source pay for the right to use the extended function at the distributed destination apparatus, it becomes unnecessary to pay an additional fee for a function that is not normally used at the distributed destination apparatus, even without there being a contract concluded on the part of the data distributed destination (i.e., the apparatus on the data-utilizing end) concerning the extended function.

While the present embodiment is based on the second embodiment to which the function utilization managing unit 35 and the billing management server 1 are added, the function utilization managing unit 35 and the billing management server 1 may be added to the third embodiment.

### Embodiment 5

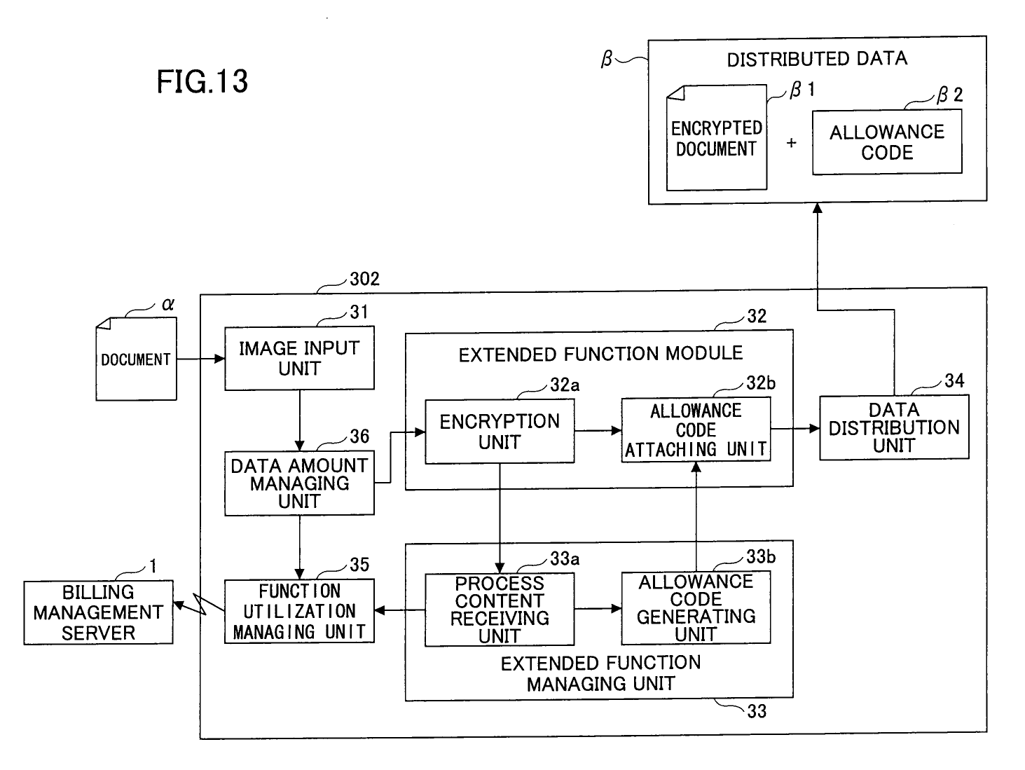

FIG. 13 shows a block diagram of an image processing apparatus at the data distributing source in a data processing system according to a fifth embodiment. The image processing apparatus at the data distributed destination is similar to that of the second embodiment shown in FIG. 6. In the block diagram of FIG. 13, portions similar to the fourth embodiment shown in FIG. 11 are designated by similar numerals.

An image processing apparatus 302 differs from the image processing apparatus 301 of the fourth embodiment in that a data amount management unit 36 for managing the amount of image data generated by the image input unit 31 is added. The output of the data amount managing unit 36 is sent to the function utilization managing unit 35. Thus, the function utilization managing unit 35 can generate billing information in accordance with the data amount of the image data generated by the image input unit 31 (by reading the document α).

In accordance with the data processing apparatus of the present embodiment, a charge is incurred only for a volume of data involving the extended function used at the data distribution. Thus, the relationship between the extended function used and the billed amount becomes clearer than in the case of the fourth embodiment, in which billing is based on the number of apparatuses to which data is distributed. Furthermore, when the data is distributed to a number of apparatuses but the amount distributed to each apparatus is small, the billed amount may decrease compared with the fourth embodiment. Thus, the user can select a billing method that is more convenient.

### Embodiment 6

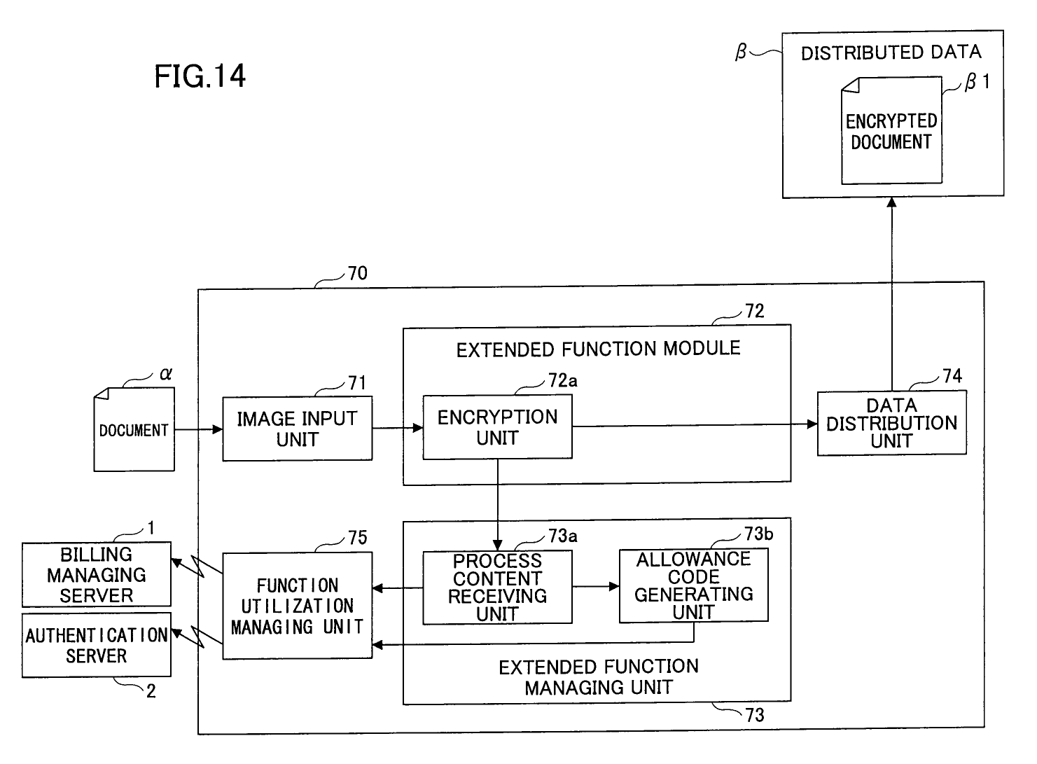

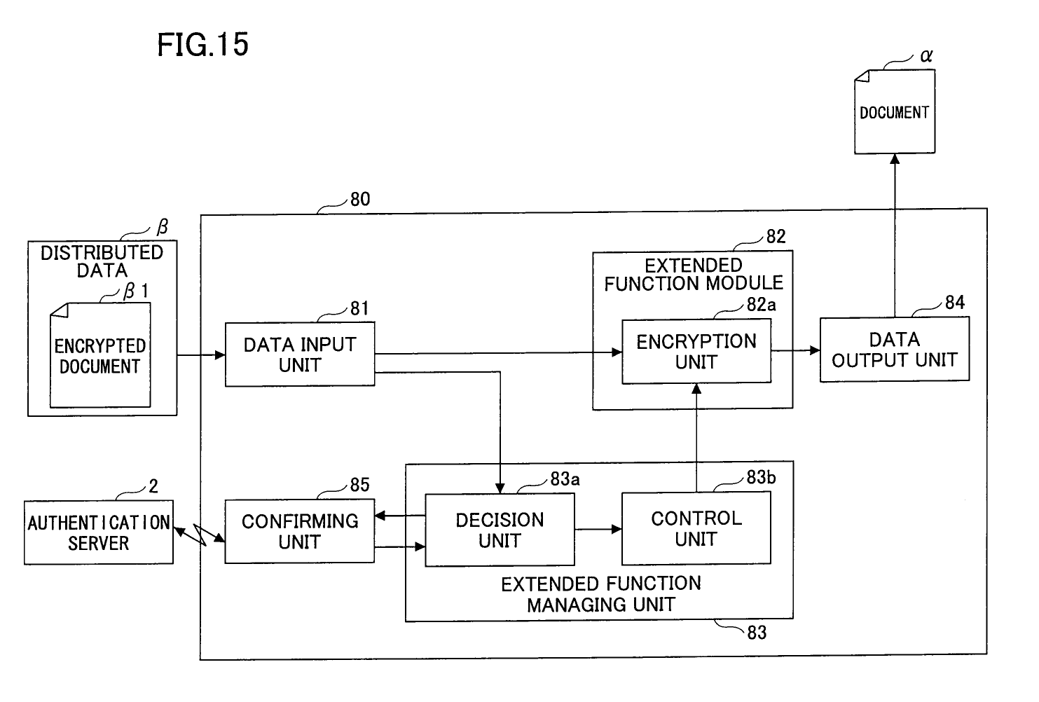

FIGS. 14 and 15 show block diagrams of image processing apparatuses at the data distributing source and the data distributed destination, respectively, in a data processing system according to a sixth embodiment of the present invention.

With reference to FIG. 14, an image processing apparatus 70 at the data distributing source includes an image input unit 71; an extended function module 72 consisting of an encrypting unit 72a; an extended function management unit 73 consisting of a process content reception unit 73a and a use allowance code generating unit 73b; a data distribution unit 74; and a function utilization managing unit 75.

The image input unit 71, the encrypting unit 72a, the process content reception unit 73a, and the data distribution unit 74 are similar to the image input unit 31, the encrypting unit 32a, the process content reception unit 33a, and the data distribution unit 34, respectively, of the image processing apparatus 301 according to the fourth embodiment shown in FIG. 11.

The allowance code generating unit 73b generates a allowance code and sends it to a function utilization managing unit 75. The function utilization managing unit 75, based on the information concerning billing sent from the process content reception unit 73a (such as the extended function or a combination of extended functions utilized, the number of apparatuses to which data is distributed, etc.), generates billing information, and sends it to a billing management server 1 on a network. The function utilization managing unit 75 also sends the decryption-function-use-allowance code received from the allowance code generating unit 73b to a function utilization authentication server 2 on the network.

With reference to FIG. 15, an image processing apparatus 80 at the data distributed destination includes a data input unit 81; an extended function module 82 consisting of a decrypting unit 82a; an extended function management unit 83 consisting of a function use decision unit 83a and a allowance control unit 83b; a data output unit 84; and a allowance confirmation unit 85.

The data input unit 81, the decrypting unit 82a, the allowance control unit 83b, and the data output unit 84 are similar to the data input unit 41, the decrypting unit 42b, the allowance control unit 43b, and the data output unit 44, respectively, of the second embodiment shown in FIG. 6.

The function use decision unit 83a analyzes the distributed data supplied from the data input unit 81 and determines whether the processing of the distributed data requires the extended function. If it does, the function use decision unit 83a accesses the function utilization authentication server 2 via the allowance confirmation unit 85, and confirms the presence or absence of an extended function use allowance code (i.e., the allowance code β2) addressed to the image processing apparatus 80. If there is the extended function use allowance code, the function use decision unit 83a receives it, and delivers it to the allowance control unit 83b.

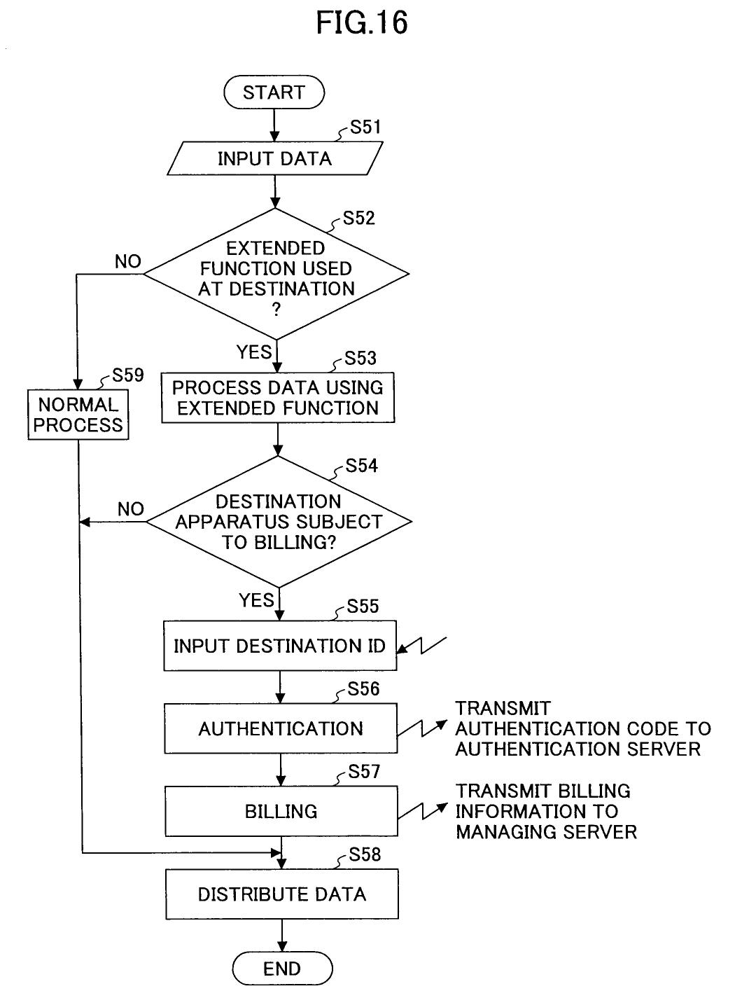

FIG. 16 shows a flowchart of an operation of the image processing apparatus 70, in which steps S51 to S54 and S57 to S59 are the same as steps S41 to S44 and S45 to S47, respectively, of FIG. 12.

In step S55, the function utilization managing unit 75 receives the ID information of the image processing apparatus 80 at the data distributed destination from the process content reception unit 73a. In step S56, the allowance code received from the allowance code generating unit 73b is sent to the function utilization authentication server 2 in association with the ID information of the image processing apparatus 80.

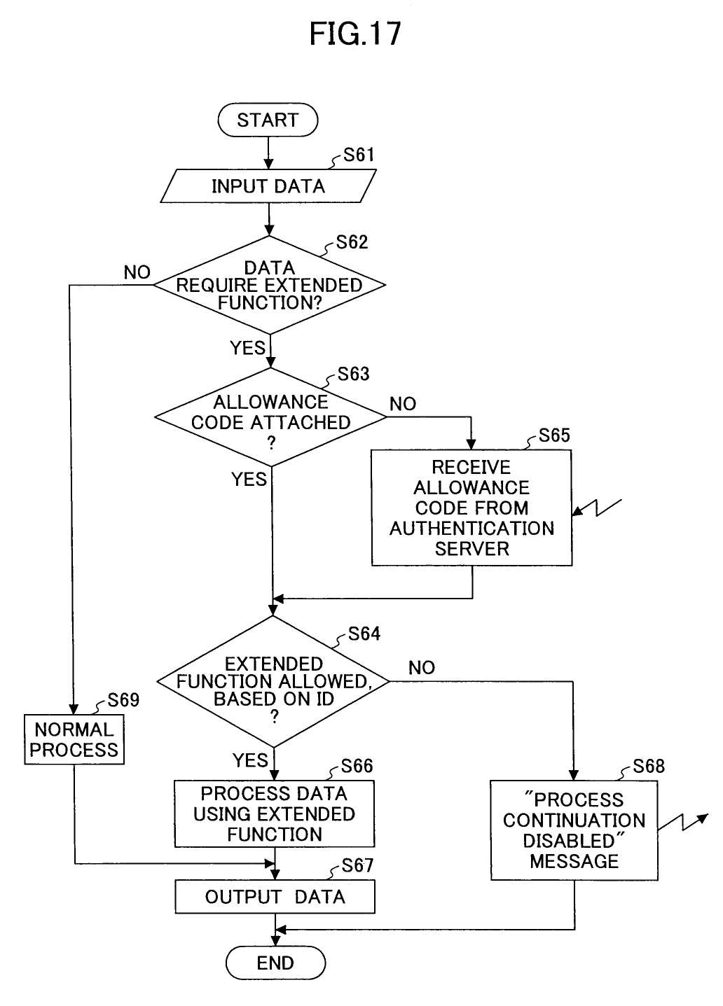

FIG. 17 shows a flowchart of an operation of the image processing apparatus 80, in which steps S61, S62, S64, S66, S67, S68, and S69 are the same as steps S31, S32, S34, S35, S36, S38, and S37, respectively, of FIG. 8.

When it is determined in step S63 that the extended function use allowance code is not attached (NO in S63), the function use decision unit 83a in step S65 accesses the function utilization authentication server 2 via the allowance confirmation unit 85, and receives the extended function use allowance code.

Thus, in accordance with the present embodiment, the extended function utilization allowance code is managed by the function utilization authentication server 2 on a network without attaching it to the distribution data. In this way, the status of use can be centrally managed. Further, by uploading both the distribution data and the extended function utilization allowance code to the server, the distribution data can be prepared and the billing process can be completed when the image processing apparatus 80 at the data distributed destination is not ready to receive the distribution data immediately.

### Embodiment 7

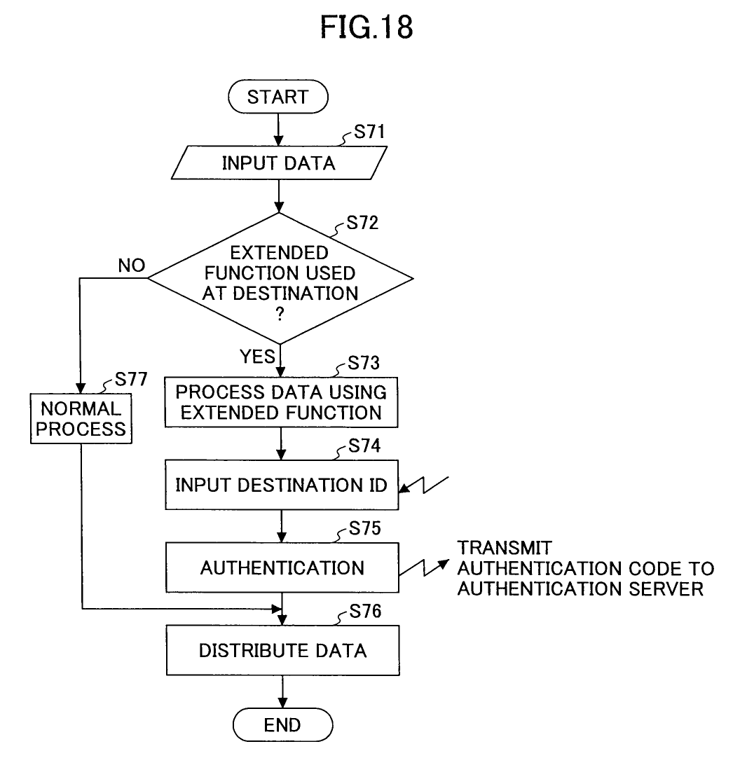

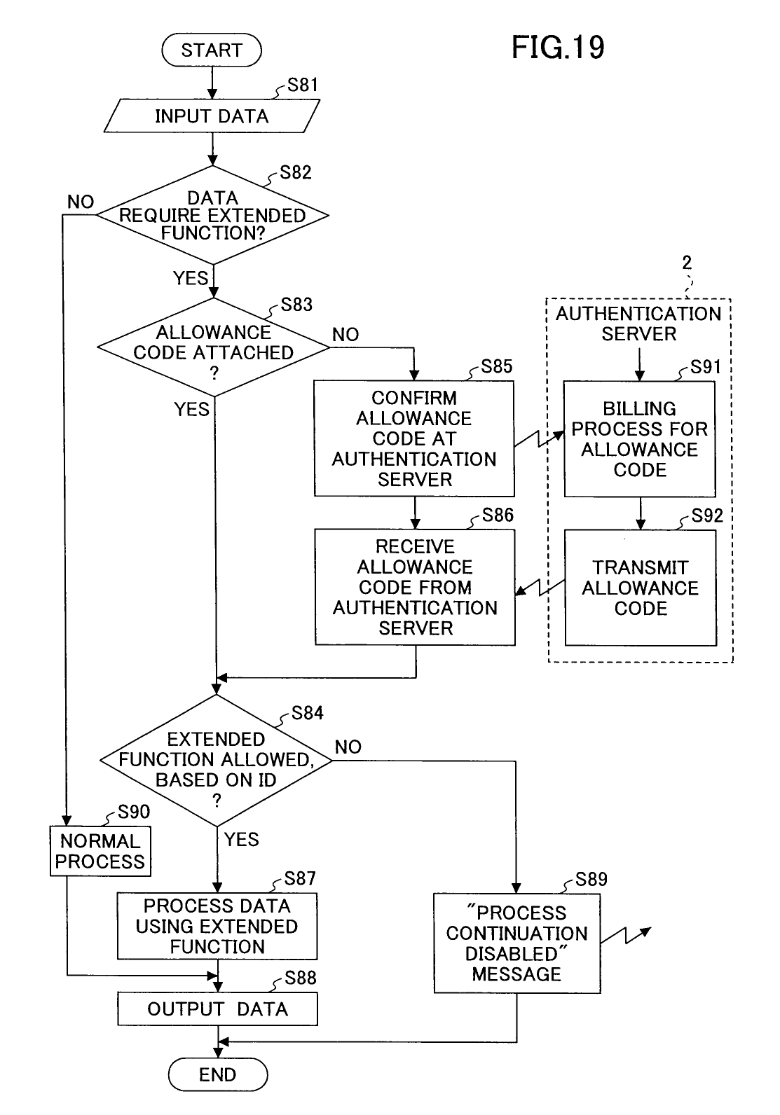

FIGS. 18 and 19 show flowcharts of operations of image processing apparatuses at the data distributing source and the data distributed destination, respectively, in a data processing system according to a seventh embodiment of the present invention. These block diagrams are similar to those of the sixth embodiment with the exception that in the present embodiment, the billing information is generated not when the image processing apparatus at the data distributing source generates data using an extended function, but when the image processing apparatus at the data distributed destination accesses the function utilization authentication server for function utilization allowance confirmation.

Steps S71 to S77 of FIG. 18 are similar to the steps S51 to S53, S55, S56, S58, and S59 of the sixth embodiment shown in FIG. 16. Specifically, the present embodiment has eliminated from the sixth embodiment the step (S54) of determining whether the image processing apparatus at the data distributed destination is subject to billing, and the step (S57) of performing a billing process.

Steps S81 to S84 and S86 to S90 of FIG. 19 are the same as the steps S61 to S69 of FIG. 17 (the sixth embodiment). Step S85, which is not included in FIG. 17, is where a allowance confirmation unit 85 of the image processing apparatus 80 accesses the function utilization authentication server 2 to confirm whether there is an extended function use allowance code addressed to the image processing apparatus 80. Thus, the operation of the image processing apparatus 80 at the data distributed destination according to the present embodiment is similar to that of the sixth embodiment.

However, the seventh embodiment differs from the sixth embodiment in the timing of performing a billing process. Specifically, the function utilization authentication server 2 implements in step S91 a billing process for an extended function use allowance code upon being accessed by the image processing apparatus 80 for the confirmation of the presence or absence of the extended function use allowance code, and, in step S92, transmits the extended function use allowance code to the image processing apparatus 80.

Thus, in accordance with the present embodiment, the extended function utilization allowance code is managed by the function utilization authentication server 2 on a network without attaching it to the distribution data, and a billing process is performed upon request from the image processing apparatus 80 at the data distributed destination for utilization of an extended function. In this way, a charge is incurred when the extended function is actually used, so that unnecessary billing can be avoided when, for example, the distribution data is not used at the image processing apparatus at the distributed destination.

Although the invention has been shown and described with reference to certain preferred embodiments thereof, it should be obvious that equivalents and modifications may occur to one skilled in the art without departing from the spirit and scope of the invention as defined by the appended claims.

For example, while the foregoing embodiments relate to image processing apparatuses, the present invention can be applied to apparatuses for processing data other than image data. The extended function is not limited to the encryption or decryption function but may include other functions.

The present application is based on the Japanese Priority Application No. 2007-222167 filed Aug. 29, 2007, the entire contents of which are hereby incorporated by reference.

What is claimed is:

1. A data processing apparatus comprising:
a unit configured to generate use allowance information allowing data to be processed at a data destination using an extended function; and
a unit configured to send the data and the use allowance information.

2. A data processing apparatus comprising:
an extended function unit configured to process input data using an extended function; and
an extended function control unit configured to operate the extended function unit based on use allowance information inputted with the input data that allows the data to be processed using the extended function.

3. The data processing apparatus according to claim 1, including a unit configured to generate billing information regarding a use of the extended function or an extended function executing program at the data destination when the data and the use allowance information, or the data and the extended function executing program are sent.

4. The data processing apparatus according to claim 3, wherein the unit configured to generate the billing information generates billing information corresponding to an amount of the input data.

5. A data processing method comprising:
a step of generating use allowance information allowing data to be processed at a data destination using an extended function; and
a step of sending the data and the use allowance information.

6. The data processing method according to claim 5, including a step of generating billing information for a use of the extended function or an extended function executing program at the data destination when the data and the use allowance information, or the data and the extended function executing program are sent.

7. The data processing method according to claim 6, including a step of determining a data amount of input data, wherein the step of generating the billing information generates billing information corresponding to the data amount.
